(19) United States
(12) Patent Application Publication
(10) Pub. No.: US 2026/0058274 A1
(43) Pub. Date: Feb. 26, 2026

(54) BATTERY STRUCTURE

(71) Applicant: SGL CARBON SE, Wiesbaden (DE)

(72) Inventors: Bernd WOHLETZ, Meitingen (DE); Maximilian SCHAEFER, Meitingen (DE)

(73) Assignee: SGL CARBON SE, Wiesbaden (DE)

(21) Appl. No.: 19/102,458

(22) PCT Filed: Jul. 5, 2023
(86) PCT No.: PCT/EP2023/068505

§ 371 Date: Feb. 10, 2025

(30) Foreign Application Priority Data
Aug. 17, 2022 (DE) 10 2022 208 548.5

(51) Int. Cl. H01M 50/229; H01M 50/24; H01M 50/249; H01M 50/28; H01M 50/293

(52) U.S. Cl. CPC H01M 50/229; H01M 50/24; H01M 50/249; H01M 50/28; H01M 50/293

(57) ABSTRACT

A battery structure including a protective device, a protective device for a battery housing, and a fiber-matrix semi-finished product for producing the protective device.

### FIELD

The invention relates to a battery structure comprising a battery housing and/or a battery and a protective device, to a protective device for a battery housing and/or a battery, and to a fiber-matrix semi-finished product for producing this protective device.

### BACKGROUND

In the course of increasing demand for modern energy storage concepts, especially in the field of electric vehicles, ever larger energy storage units, in particular battery modules and batteries having the highest possible energy density, are being installed. If the chemicals and energy contained in the batteries are released in an uncontrolled manner, this can result in catastrophic fires. Among other things, such a process can be triggered by mechanical damage to the batteries. Battery cases made of fiber composite material are increasingly used because they have advantages over metals in the combination of the requirements for fire protection, crash safety, insulation, and lightweight construction. Due to their typical layer-based structure and the process-related simultaneous production of material and the component consisting thereof, fiber composite materials offer much better options for adapting to the specific requirements of the component compared to metals.

Fiber composite components with which the above requirements profile can better be met, in particular by realizing different functionalities, such as a flame-retardant effect or electromagnetic shielding, in technical items, are already known from the prior art.

US 2005/0170238 A1 discloses, for example, a battery housing which is formed from a flame-retardant polymer composition made of high-density polyethylene, which can comprise a glass fiber reinforcement and a fire-resistant additive. During production, the fire-resistant additive is mixed in the melt with the polyethylene to be protected and the mass is subsequently pressed into the desired shape. US 2020/0152926 A1 describes a lid for a battery pack of an electric vehicle with a frame consisting of a layered composite. A first layer of the composite comprises a so-called “shear panel” which has a fiber-reinforced composite layer which is intended to counteract a shear deformation during an impact. As a separate element, the layered composite comprises a fire-and abrasion-resistant second functional layer which is deposited on the shear panel and which faces the battery when the shear panel is connected to the frame of the vehicle.

Although components can be better protected from external influences such as fire or mechanical loads using the fiber composite components described above, in many applications, particularly in the field of battery technology, this protection is inadequate and/or requires such a solid design of the protective device, such as the shear panel, that the use of composite materials is no longer competitively possible. Alternatively, substantial amounts of flame-retardant or flame-extinguishing additives such as phosphates or aluminum hydroxide can be added to the composite component to improve the fire protection properties. However, these adjustments lead to performance losses on both the process side (increase in scrap) and the product side (increase in weight).

### SUMMARY

Against this background, the object of the present invention was therefore to provide a battery structure with a protective device by means of which the drawbacks described above can be overcome and which has an improved protective effect with regard to flame-abrasive and/or mechanical loads, without this being accompanied by reduced processability and/or increased component weight and/or increased installation space.

This object is achieved according to the invention by a battery structure comprising a battery housing and/or a battery, and a protective device, wherein the protective device is preferably arranged on one of the inner sides of the battery housing and/or on the battery, wherein the protective device has a
a) fiber material comprising long and/or continuous fibers, and
b) a matrix material,
wherein the fiber material is at least partially, preferably completely, embedded in the matrix material, wherein the matrix material comprises or consists of an unsaturated compound, preferably an unsaturated polymer.

The invention relates to a battery structure, preferably for an electric vehicle, comprising a protective device and a battery. Alternatively or in addition to the battery, the battery structure comprises a housing for a battery. In the first case (“alternatively”), the battery structure does not necessarily have to comprise a battery, i.e., the invention already relates to a structure which only comprises a battery housing with an additional protective device (and optionally a battery). In other words, the protective device is then an additional, separate element to the battery housing, which can optionally comprise a battery.

However, according to the invention, the protective device can also form the battery housing or part of the battery housing, preferably the bottom plate or cover plate, for the battery, i.e., the protective device is the battery housing (or part thereof). The battery structure then necessarily comprises a battery.

Battery modules are often used in modern battery structures. These are arrangements with a plurality of batteries which are grouped together in a, usually closed, frame and connected to the outside by a uniform boundary. Typically, a plurality of such structurally subordinate battery modules are arranged in a battery housing. The protective device according to the invention can be suitable for protecting a single module, i.e., arranged between the battery housing and the battery module. However, the protective device according to the invention can also protect a plurality of modules or even all of them.

Since the protective device according to the invention provides protection against thermal and/or flame exposure in particular, the protective device is preferably arranged between the battery housing and the battery module.

The protective device according to the invention can also be a so-called “intercell barrier” of a battery module, i.e., a protective plate that separates individual batteries of the battery module from one another. In the event of a fire, such a plate prevents the flames from one battery from spreading to the neighboring one(s). Particularly preferably, the protective device according to the invention is an “intercell barrier”between pouch cells of a battery module.

In one preferred embodiment, the protective device according to the invention is arranged on the inside of the battery housing, preferably between the battery and the battery housing. In another embodiment of the invention, the protective device according to the invention is arranged on the outside of the battery housing.

The protective device according to the invention is a fiber composite component which comprises a fiber material comprising or consisting of long and/or continuous fibers and a matrix material with an unsaturated compound, in particular an unsaturated polymer material. What is meant by unsaturated compounds is organic chemical compounds with a molecular structure containing one or more carbon-carbon double or triple bonds. However, in the context of the present invention, the term also includes molecular structures with carbon-nitrogen double bonds or carbon-nitrogen triple bonds. Particularly preferred are polymers which have one or more carbon-carbon double or triple bonds. In this context, the term polymer is understood to mean a chemical substance which contains more than 50 wt. %, preferably more than 70 wt. %, more preferably more than 80 wt. %, even more preferably more than 90 wt. % and most preferably more than 95 wt. % macromolecules.

“Macromolecules” are molecules that are made up of one or more identical or similar structural units, the constitutional repeating units (IUPAC. Compendium of Chemical Terminology, 2nd ed. (the “Gold Book”), A. D. McNaught, A. Wilkinson, Blackwell Scientific Publications, Oxford (1997), S. J. Chalk. ISBN 0-9678550-9-8). Such macromolecules have more than 10 repeating units, preferably more than 15 repeating units. The molecular weight is preferably at least 3,000 g/mol, preferably at least 5,000 g/mol, particularly preferably at least 7,000 g/mol and most preferably at least 10,000 g/mol

Polymers are typically prepared by reacting monomers or oligomers containing one or more of the constitutional repeating units in a polymerization reaction. An oligomer is a molecule that is formed from a plurality of monomers and is therefore made up of a multiplicity of structurally identical or similar structural units. In the context of the invention, oligomers are those molecules which are produced from a reaction of 2-10, preferably 2-8, preferably 3-7 monomers.

According to the invention, “resins” are understood to be precursors of thermosetting plastics, i.e., polymers (see IUPAC. Compendium of Chemical Terminology, 2nd ed. (the “Gold Book”), A. D. McNaught and A. Wilkinson, Blackwell Scientific Publications, Oxford (1997)), which can be used in particular as components of coatings, varnishes and paints. Particularly preferred are resins obtained by polyaddition or polycondensation, in particular polyurethane (PU), polyester, polyamide, urea, melamine, formaldehyde, PVC, acrylic or epoxy resins.

A “fiber composite component” is understood to mean a material of two or more connected materials which have different material properties than its individual components and which can serve as a component of a technical item. Such a component may, for example, be a plate or a housing or part of a housing, such as a bottom plate or cover plate. However, the term “fiber composite component” also includes fiber composite components which can form a technical item per se. The fiber composite component comprises at least one fiber material and a matrix material. The fiber composite component according to the invention is preferably a glass fiber reinforced plastic (GRP) or a carbon fiber reinforced plastic (CFRP).

The protective device according to the invention, i.e., the fiber composite component according to the invention, is suitable for protecting the battery and/or the battery housing and/or for protecting against the battery, more precisely for protecting against dangers caused by the battery. In particular, the protective device is suitable for protecting the battery and/or the battery housing against mechanical loads and/or against thermal and/or flame exposure caused by the battery, for example if a fire occurs due to overheating or an uncontrolled chemical reaction of the battery chemicals. In other words, the protective device protects the battery and/or the battery housing against compressive and/or tensile and/or shear and/or impact loads, usually introduced from the outside, which can damage the battery, and, in the event of a fire in the battery, prevents or at least reduces thermal and/or flame exposure for the components surrounding the battery (such as the battery housing, if present).

What is meant by long fibers is fibers with a length L=1 of up to 50 mm, while what is meant by continuous fibers (also unidirectional fibers) is fibers with a length L>50 mm. Preferably, the length of the fibers of the fiber material is >30 mm. The use of continuous fibers in the protective device according to the invention and/or the fiber-matrix semi-finished product according to the invention is preferred. This results in components with particularly advantageous mechanical properties.

The matrix material of the protective device according to the invention serves for at least partially, preferably completely embedding the fiber material, and optionally also for at least partially, preferably completely embedding an optional additive and/or for at least partially, preferably completely dissolving an optional additive. It holds the fibers of the fiber material in their position and transfers and distributes stresses between them. It is preferably a polymer material, in particular a thermosetting polymer material. It is preferably a thermosetting polymer material produced from a resin and a curing agent. In the preparation, accelerators, activators and release agents are preferably used which are then preferably part of the matrix material within the meaning of the present invention.

Preferably, the matrix material, with the exception of an optionally incorporated additive and the incorporated fiber material, has a substantially homogeneous chemical composition, i.e., material boundaries, with the exception of the optionally incorporated additive and the incorporated fiber material, are present not at all or only in adjacent regions of the fiber composite component.

The spatial dimensions of the protective device itself are not limited within the scope of the invention. The protective device can preferably be a plate, such as a fire protection panel. The protective device is preferably monolithic or a fiber composite sandwich panel, i.e., a panel-shaped component in sandwich construction. In the case of a sandwich construction, materials having different properties are assembled in layers to form a component or semi-finished product. Generally, a sandwich panel comprises force-absorbing, fixed outer cover layers, which are kept at a distance by a relatively soft, lightweight core material. The core is preferably made of solid material (e.g., polyethylene, balsa wood), foam (e.g., rigid foam, metal foam), insulating material (e.g., hard foam, mineral wool) or honeycomb lattice (e.g., paper, cardboard, metal, plastic). It transmits thrust forces occurring and supports the outer cover layers. In the case of a fiber composite sandwich panel, at least one of the layers, usually one of the cover layers, is formed from a fiber composite. All outer cover layers are preferably made of a fiber composite. Preferably, at least one, preferably all, cover layers have a wavy structure. The protective device preferably comprises surface, handling, protective, in particular UV-protective, marking and color films, as well as film for improving electromagnetic compatibility (EMC). Particularly preferred are also covering functional layers such as protective films for transport and in-mold coatings, for example for better paint ability.

The protective device can also comprise pores, i.e., air and/or gas inclusions, which, however, preferably do not constitute more than 5 vol. % of the total volume of the protective device.

In its intended uses, the protective device is often exposed to high mechanical loads and therefore preferably has a particularly pronounced mechanical resistance and/or strength.

In one preferred embodiment of the invention, the fiber composite component, i.e., the protective device, therefore has a flexural strength determined according to DIN EN ISO 14125: 2011-05 of ≥100 MPa, preferably ≥200 MPa, more preferably ≥400 MPa, still more preferably ≥600 MPa, even considerably more preferably ≥750 MPa, and most preferably ≥1,000 MPa, but generally not more than 20,000 MPa.

In one preferred embodiment of the invention, the fiber composite component has a flexural modulus of elasticity determined according to DIN EN ISO 14125: 2011-05 of ≥10 GPa, preferably ≥20 GPa, more preferably ≥30 GPa, still more preferably ≥50 GPa, even considerably more preferably ≥70 GPa, and most preferably ≥100 GPa, but generally not more than 1,000 GPa.

The protective device does not necessarily have to have the mechanical properties mentioned above. For example, the protective device can also be used in combination with a second protective device made of a metallic material, which then essentially serves for the mechanical protection of the battery and/or the battery housing. In one preferred embodiment of the invention, the battery structure therefore comprises a second protective device made of a metallic material.

The battery structure according to the invention can preferably be a stationary battery structure, but in another embodiment it can also be a battery structure for a means of transport, for example a motor vehicle or an aircraft. The term battery within the meaning of the invention is not limited to primary batteries, i.e., batteries that can no longer be charged, but also comprises—even particularly preferably—secondary batteries, i.e., rechargeable batteries. The battery is particularly preferably a lithium-ion battery, in particular a lithium-ion battery used for an electric vehicle.

Conventional carbon-based protective devices without unsaturated carbon-carbon or carbon-nitrogen bonds in the matrix act as sacrificial material, i.e., during thermal runaway, e.g. when the battery explodes due to overheating, the fully saturated matrix materials are essentially completely oxidized to gaseous products such as CO₂ and thus broken down. An example of this is filled epoxy composites. Other non-carbon-based matrix materials such as silicones, on the other hand, act as insulators, but they come with non-temperature-stable binders that fail early under thermal and mechanical loads.

The inventors were able to discover that flame retardancy can be significantly improved by using a matrix material with unsaturated carbon bonds. Without being tied to this theory, the inventors assume that the unsaturated carbon bonds in the matrix material act as carbonization centers in the event of thermal runaway, i.e., that in this case cyclization, dehydrogenation and aromatization processes take place, creating a (partially) aromatic, carbon-like structure. These strongly endothermic processes lead to the absorption and dissipation of the energy incident on the protective device as a result of the thermal runaway. The carbonized layer, acting as an insulator, also shields the matrix material located beyond the carbonized layer from the heat. Electrical insulation can further be achieved through the non-carbonized regions of the matrix material. The long-fiber or continuous-fiber structure stabilizes the carbon structure that forms during thermal runaway and allows the mechanical loads that occur during battery explosion to be absorbed, with only minimal deformation of the protective device. In other words, the synergistic interaction of fiber material and matrix material allows carbonization without the resulting slightly brittle structure being damaged by cracking or similar. In most cases, this can prevent burnthrough of the composite structure. In addition, the long and/or continuous fibers allow the protective device to have improved properties with regard to mechanically transferable loads (tension, compression, shear) and improve the flame retardant effect. In contrast to short fibers, inhomogeneities (e.g. local fiber volume content fluctuations) in the component only occur to a minor extent and, in addition, unstable structures such as exposed short fibers can be avoided during combustion.

These functions described above can be achieved in a locally focused manner via locally limited use of the unsaturated compound. For example, an unsaturated, preferably thermosetting, polymer material can be arranged only in selected regions of the matrix material, in particular if only certain regions of the protective device are arranged in the immediate vicinity of the battery, the battery housing or the battery module.

The matrix material according to the invention can also be a multi-component matrix material, in particular one which is formed by a mixture of different polymer materials, wherein at least one of these polymer materials is an unsaturated polymer material. The unsaturated polymer material is then preferably arranged in regions in the immediate vicinity of the battery, the battery housing or the battery module. In such a multi-material matrix approach, for example, a phenolic resin, such as a novolak, can first be applied to a mold and consolidated at locally critical points that, for example, are in direct contact with the battery during later use. In the subsequent step, a second saturated resin system (e.g. an epoxy resin) is applied to the consolidated structure and the component is cured.

In one preferred embodiment of the invention, the matrix material is a matrix material cured by the addition of a curing agent.

In one preferred embodiment of the invention, the proportion by weight of the unsaturated, preferably polymeric and thermosetting, compound in the matrix material is ≥10 wt. %, preferably ≥20 wt. %, more preferably ≥40 wt. %, even more preferably ≥60 wt. %, even more preferably ≥80 wt. % and most preferably ≥90 wt. %. In one particularly preferred embodiment, the matrix material consists of the unsaturated compound, which is preferably in the form of a thermosetting polymer material.

In one preferred embodiment, the volume ratio of matrix material to fiber material in the protective device, i.e., the fiber composite component, is 8:1 to 1:10, preferably 5:1 to 1:8, and particularly preferably 2:1 to 1:5.

In one preferred embodiment, the weight ratio of matrix material to fiber material in the fiber composite component is 5:1 to 1:20, preferably 3:1 to 1:10, and particularly preferably 1:1 to 1:8.

In one preferred embodiment, the volume ratio of matrix material to optional additive in the fiber composite component is 100:1 to 1:5, preferably 50:1 to 1:3, and particularly preferably 2:1 to 1:2.

In one preferred embodiment, the weight ratio of matrix material to optional additive in the fiber composite component is 100:1 to 1:10, preferably 50:1 to 1:6 and particularly preferably 4:1 to 1:4.

In one preferred embodiment, the proportion by weight of fiber material in the total mass of the fiber composite component is from 10 to 95 wt. %, preferably 20 to 90 wt. %, more preferably 30 to 85 wt. %, still more preferably 40 to 80 wt. %, and most preferably 50 to 75 wt. %.

In one preferred embodiment, the volume ratio of matrix material to fiber material in the functional region is 8:1 to 1:15, preferably 2:1 to 1:10, and particularly preferably 1:1 to 1:10. By adjusting the fiber volume content within the limits described above, carbonization behavior can be further improved.

In one preferred embodiment, the weight ratio of matrix material to fiber material in the functional region is 5:1 to 1:30, preferably 2:1 to 1:20, and particularly preferably 1:1 to 1:15.

In the protective device, the fiber volume content is preferably in a range of 30-70 vol %, preferably 35-65 vol %, more preferably 40-60 vol %, and most preferably 45-55 vol %. This allows suitable mechanical properties for protection, in particular suitable ductility, to be achieved.

In one preferred embodiment of the invention, the fiber material has, at least partially, preferably completely, a surface structure, preferably a textile surface structure, which is partially, substantially (i.e., more than 90 vol. %), or even completely embedded in the matrix material.

Particularly preferably, the surface structure is selected from the group consisting of laid scrim, knitted fabric, woven fabric, braided fabric, nonwoven fabric or mixtures thereof.

According to the invention, nonwoven is understood to mean a structure of fibers of limited length, continuous fibers (filaments) or cut yarns of any type and any origin, which are joined in some way to form a fiber layer and have been connected to one another in some way. Excluded from this is the crossing or intertwining of yarns, as occurs in weaving, knitting, machine-knitting, lace weaving, braiding and production of tufted products. This definition corresponds to the standard DIN EN ISO 9092. According to the invention, the term nonwoven fabric also covers felt materials. However, films and papers do not belong to the nonwoven fabrics.

In the context of the invention, braiding is understood to mean the regular interleaving of a plurality of strands made of flexible material. The difference from weaving is that, during braiding, the threads are not supplied at a right angle to the main direction of production of the product.

Particularly preferred within the scope of the invention is the use of a fiber material in the form of a fabric. According to the invention, woven fabric is understood to mean a textile fabric consisting of two thread systems, warp (warp threads) and weft (weft threads), which, in view of the fabric surface, intersect at an angle of exactly or approximately 90° in the form of a pattern. Each of the two systems can be constructed from a plurality of warp or weft types (e.g., basic, pile and filling warp; base, binding and filling weft). The warp threads run in the longitudinal direction of the woven fabric, parallel to the selvage, and the weft threads in the transverse direction, parallel to the fabric edge. The threads are connected to the woven fabric predominantly by frictional engagement. In order for a woven fabric to be sufficiently non-slip, the warp and weft threads must usually be woven relatively tightly. Therefore, apart from a few exceptions, the woven fabrics also have a closed fabric appearance. This definition corresponds to the standard DIN 61100, Part 1.

According to the invention, the terms woven fabric and nonwoven also include textile materials that have been tufted. Tufting is a method in which yarns are anchored into a woven fabric or a nonwoven with a machine operated by compressed air and/or electricity.

According to the invention, knitted fabrics are understood to mean textile materials which are produced from thread systems by knitting. These include both crocheted and knitted materials.

According to the invention, a laid scrim is understood to mean a fabric consisting of one or more layers of stretched threads running in parallel. The threads are usually fixed at the crossover points. The fixing takes place either by material bonding or mechanically by friction and/or positive locking. The laid scrim is preferably selected from a monoaxial or unidirectional, biaxial or multiaxial scrim.

Preferably, the fiber material has an anisotropic structure, i.e., within the functional layer according to the invention, the fibers have a specific fiber orientation. Anisotropic mechanical behavior of the layered composite can thereby be produced.

The fibers of the fiber material are preferably selected from the group consisting of glass fibers, carbon fibers, ceramic fibers, basalt fibers, boron fibers, steel fibers, polymer fibers such as synthetic fibers, in particular aramid fibers and nylon fibers, or mixtures of the aforementioned. Glass fibers and carbon fibers are particularly preferred. With appropriate fibers, protective devices according to the invention can be produced with particularly high mechanical resistance.

Carbon fibers are particularly preferred for protective devices for aircraft applications, in particular by virtue of their weight advantage and higher modulus of elasticity, while glass fibers are particularly preferred in automotive applications.

In another preferred embodiment, the fibers of the fiber material are natural fibers, in particular natural polymer fibers.

Natural fibers are understood to mean fibers which originate from natural sources such as plants, animals or minerals and can be used directly without further chemical conversion reactions. Examples according to the invention are flax, jute, sisal or hemp fibers, and also protein fibers or cotton. According to the invention, it is also possible to use regenerated fibers, i.e., fibers which are produced via chemical processes from naturally occurring, renewable raw materials.

Corresponding fiber materials are characterized by improved recyclability and thus a particularly high level of sustainability.

The one or more unsaturated carbon-carbon and/or carbon-nitrogen bonds of the unsaturated compound are converted into a (partially) aromatic, carbonaceous structure during thermal runaway. The inventors assume that the use of an unsaturated carbon-nitrogen bond leads to a N₂ elimination, which is part of the carbonization process. In one preferred embodiment of the invention, the functional group therefore has a carbon-nitrogen bond, in particular a carbon-nitrogen double bond.

In another preferred embodiment of the invention, the functional group has an unsaturated carbon-carbon bond, in particular a carbon-carbon double bond.

More preferably, the functional group has two, three, four, five or more unsaturated carbon-carbon bonds and/or unsaturated carbon-nitrogen bonds.

In one preferred embodiment of the invention, the unsaturated compound is a thermosetting polymer material with at least one constitutional repeating unit having at least one functional group that has an unsaturated carbon-carbon bond and/or an unsaturated carbon-nitrogen bond.

In one preferred embodiment, the functional group has two or more bonds selected from the group consisting of unsaturated carbon-carbon bonds and unsaturated carbon-nitrogen bonds and wherein at least two of these bonds are conjugated. Conjugation of the unsaturated bonds facilitates the formation of an aromatic structure, as a result of which carbonization processes are preferred and thus occur to a greater extent.

Preferably, the functional group is part of an aromatic system, such as part of a furanyl, thiophenyl, pyrolyl, imidazolyl, pyrazolyl, oxazolyl, thiazolyl, phenyl, benzoyl, hydroxyphenyl or pyiridinyl group. The presence of an aromatic system energetically favors further aromatization during the carbonization process. Particularly preferably, the aforementioned groups are part of one or more repeating units when the unsaturated compound is a polymer.

Preferably, the unsaturated compound is a thermosetting polymer selected from the group consisting of phenolic resins, cured melamine resins, cured furan resins and cured polyurethane resins. Particularly preferred are materials obtained from the curing of phenolic resins, preferably novolaks. The thermosetting polymer materials are preferably almost completely crosslinked, where almost completely means that at least 80% of the potentially crosslinkable functional groups are crosslinked.

Preferably, the thermosetting polymer material is a phenolic resin obtained by crosslinking a phenol formaldehyde resin. The molar ratio of formaldehyde to phenol in the curable phenol formaldehyde resin is particularly preferably in the range between 1:0.4 and 1:2.5, in particular 1:1.2 to 1:2.

The thermosetting polymer material according to the invention is preferably obtained by reacting a resin, such as a phenolic resin, with a curing agent. The curing agent is preferably selected from the group consisting of formaldehyde donors, such as hexamethylenetetramine, or melamine or urea condensates containing methylol groups. The curing agents are preferably used in an amount of 2.5 to 50 wt. %, preferably 5 to 15 wt. %, based on phenolic resin.

In one preferred embodiment of the invention, the matrix material and/or the unsaturated compound has a carbon yield upon thermal pyrolysis of ≥40%, preferably ≥50%, even more preferably ≥55%, even more preferably ≥60% and most preferably ≥65%. The carbon yield can be determined via thermogravimetric analysis, which requires the thermal treatment of an approx. 30 mg sample in a N₂ atmosphere (60 ml/min purge gas rate) and a linear heating program from 20° C. to 1000° C. is run at a heating rate of 10° C./min. The carbon yield corresponds to the ratio of remaining mass to the initial mass of the matrix material or of the unsaturated compound. With a correspondingly high yield, the advantages of the invention are particularly pronounced.

The matrix material of the protective device according to the invention can further comprise an additive.

The additive is particularly preferably a flame retardant preferably selected from the group consisting of halogenated and/or nitrogen-based flame retardants, inorganic flame retardants, such as graphite salts, aluminum trihydroxide, antimony trioxide, ammonium polyphosphate, aluminum diethylphosphinate, mica, muscovite, guanidines, triazines, sulfates, borates, cyanurates, salts thereof, and mixtures thereof. The flame retardant activity of the protective device can be further increased thereby. In contrast to the protective devices known from the prior art, a significantly lower content of additives, in particular flame retardants, can be used due to the intrinsic flame retardant activity as a result of the carbonization behavior, which has a particularly positive effect on the mechanical properties of the protective devices. In one preferred embodiment of the invention, the matrix material comprises ≤50 wt. % additives, preferably ≤45 wt. % additives, more preferably ≤40 wt. % additives, even more preferably ≤35 wt. %, even more preferably ≤30 wt. % additives and most preferably ≤25 wt. % additives, but preferably also ≥1 wt. %.

In other preferred embodiments, the additive is selected from the group consisting of antioxidants, light stabilizers, in particular UV stabilizers, plasticizers, foaming agents, electrical conductors, heat conductors, dyes, fillers for improving the mechanical properties, such as impact modifiers, or rubber or thermoplastic particles, and mixtures of the aforementioned.

The additive can be present in dissolved or dispersed form in the matrix material. If it is dispersed, it is preferably contained in the form of a powder, flakes, tubes or mixtures of the aforementioned forms.

If the additive is a flame retardant, it is preferably selected from the group of active, i.e., cooling, flame retardants or from the group of passive, i.e., insulating, flame retardants. Particularly preferably, the flame retardant is an intumescent flame retardant.

Finally, the matrix materials according to the invention can also contain wetting agents. Wetting agents are surface-active substances that usually have a hydrophobic molecular part and a hydrophilic molecular part. A distinction is made between non-ionic, anionic and cationic surfactants. Wetting agents reduce the viscosity of the resin. This allows the penetration of the fiber material to be improved, which ultimately leads to a stronger bond between the fiber material and the matrix material. The synergistic effect, in particular the stabilization of the (partially) carbonized structure, is thereby improved.

Non-ionic surfactants are, for example, esters and amides of fatty acids (saturated or unsaturated carboxylic acids, which generally have 4 to 26 carbon atoms in the molecule), fatty amines (primary amines, which generally have 6 to 22 carbon atoms in the molecule) or polyethylene glycol ethers or polypropylene glycol ethers of alcohols, alkylphenols or fatty acid alkanolamides. Anionic wetting agents are, for example, salts of alkyl malonic or alkyl succinic acid, alkyl sulfonates, fatty acid ester sulfonates, perforated alkyl sulfonates or sulfated fatty acid amides. Cationic surfactants are substances such as fatty amine salts, salts of alkylenediamines and polyamines, alkylbenzylammonium salts or alkylpyridinium salts.

The fiber composite component, i.e., the protective device, is preferably designed integrally, i.e., in one piece, i.e., monolithically. The fiber composite component is particularly preferably obtained during its production by integral curing. In another preferred embodiment, the fiber composite component is a fiber composite sandwich panel, i.e., a panel-shaped component in sandwich construction.

The invention also relates to a protective device for a battery housing and/or a battery and/or a battery module as defined in one of the claims and the preceding and following sections of the description text.

The protective device is particularly preferably a battery housing, in particular a battery housing for the battery of an electric vehicle, such as a lithium-ion battery.

Preferably, the protective device is a component of a means of transport, in particular a motor vehicle component such as a body component. Particularly preferably, the protective device is underbody protection (also called an impact protection plate or underrun protection) or a bumper, or a battery housing, battery housing part and is preferably in the form of a protective plate.

The protective device may also be part of an aircraft or spacecraft, a rail vehicle component or a part of the aforementioned. Further preferred motor vehicle components are selected from the group consisting of trunk cargo floors, instrument panels, door and roof claddings, underbody protection parts, structural components, wheel housings, engine compartment parts, brake and clutch linings and disks, acoustic insulation, shear panels, and seals.

The use as part of a battery housing (which does not necessarily have to be part of a motor vehicle), in particular for a lithium ion battery, is particularly preferred. The fiber composite component is particularly preferably the bottom plate or cover plate.

The protective device can also be an “intercell barrier”.

The invention also relates to a fiber-matrix semi-finished product, preferably a prepreg, for producing a protective device according to the invention comprising a fiber material comprising or consisting of long and/or continuous fibers and a preferably curable, in particular thermosetting, resin composition which comprises an unsaturated compound, preferably in the form of a resin with at least one constitutional repeating unit, wherein the fiber material is at least partially, preferably completely, embedded in the preferably thermosetting resin composition.

The at least one constitutional repeating unit of the preferably used resin comprises at least one functional group having an unsaturated carbon-carbon bond or an unsaturated carbon-nitrogen bond.

Preferably, the fiber-matrix semi-finished product is designed such that at least one surface of the semi-finished product is substantially completely, i.e., more than 70%, preferably completely, covered with matrix material. Such a fiber-matrix semi-finished product is characterized by particularly good processability. In particular, contacting with additional fiber layers to produce complex components can take place via the completely covered side, so that the smallest possible interlaminar pore volume is created. The resulting protective devices can therefore withstand particularly strong mechanical loads. The invention also relates to a protective device obtained by thermally joining such semi-finished products.

The preferably used curable resin composition of the fiber-matrix semi-finished product comprises or is preferably a phenolic resin, in particular a novolak, which is particularly preferably dry, i.e., comprises less than 10 wt. %, preferably less than 5 wt. %, even more preferably less than 1 wt. %, solvent. Such dry, preferably thermosetting resin compositions of the fiber-matrix semi-finished product are preferably obtained by partial curing using a curing agent, preferably an amine curing agent such as hexamethylenetetramine. The aforementioned phenolic resins, in particular novolaks, in particular in the aforementioned preferred embodiments, exhibit high storage and handling stability (in particular low or no stickiness) at room temperature, but also up to temperatures of 60° C. This high stability is particularly pronounced when the phenolic resins, in particular novolaks, are at the “B-stage” since then no further polymerization and crosslinking reactions take place, or only take place to a minor extent. This is particularly preferably achieved by partially curing the preferably thermosetting compositions using an amine curing agent such as hexamine. The preferably thermosetting resin composition, which in particular comprises a novolak, preferably has a glass transition temperature (T_{g}) of ≥4° C., preferably ≥8° C., more preferably ≥12° C., even more preferably ≥15° C. and most preferably ≥20° C. By using a novolak, especially with the T_{g} values described above, the fiber-matrix semi-finished product is prevented from having a tacky feel. This also results in the fiber-matrix semi-finished product having particularly good cuttability.

The proportion by weight of the fiber material in the fiber-matrix semi-finished product is preferably in the range of 25-60 wt. %, preferably 30-55 wt. %, even more preferably 35-50 wt. % and most preferably 35-50 wt. %. Within these value ranges, both dry spots in the fiber-matrix semi-finished product and excessive matrix outflow during the process can be avoided.

The use of a novolak generally makes it possible to avoid coloration, such as that which occurs with resols, in the fiber-matrix semi-finished product and/or the protective device.

When using a phenolic resin for the fiber-matrix semi-finished product, in particular a novolak, the thermosetting composition is preferably at the so-called “B-stage”, i.e., the composition is still swellable and meltable, but is already insoluble in solvents. This stage is usually achieved via thermal treatment at a maximum temperature of 160° C. Such resins allow, in particular, easy integration of surface, handling, protective, in particular UV-protective, marking and color films, as well as films for improving electromagnetic compatibility (EMC). Particularly preferred are also covering functional layers such as protective films for transport and in-mold coatings, for example for better paintability. Preferably, the fiber-matrix semi-finished product therefore comprises such films. The protective device according to the invention also preferably comprises such films. The use of phenolic resins, especially at the “B-stage”, also allows near-net-shape pressing due to their low flowability.

In terms of process technology, the use of the phenolic resins described above at the “B-state”, especially novolaks, allows further simplification, because the reaction is already very advanced before final curing during final component production. This simplifies and speeds up the overall process. In the case of using a novolak with an amine curing agent, only ammonia is split off during final curing of the fiber-matrix semi-finished product, in which the protective device according to the invention is obtained, but the basic structure of the curable composition at the “B-state” is no longer changed. This leads to a high degree of application variability (a kind of “phenolic-resin-based organosheet”) and a very short reaction time in the final curing step. In addition, ammonia escapes much more easily from the resin matrix, so that significantly less pore formation is observed in comparison with water-separating curing (e.g. when curing with compounds containing hydroxymethyl groups). This makes it possible to produce thicker-walled and more stable protective devices.

The invention also relates to a system (“kits of parts”) for producing a fiber-matrix semi-finished product as defined in claim 14 and above, wherein the composition comprises a fiber material and a preferably thermosetting resin composition in powder form. The resin composition is preferably dry, i.e., it comprises less than 10 wt. %, preferably less than 5 wt. %, even more preferably less than 1 wt. %, solvent. The dry, preferably thermosetting compositions preferably contain curing agents, in particular amines such as hexamethylenetetramine (also “hexamine”). The preferably thermosetting composition in this powder system is preferably at the “A-stage”, in particular at the “A2-stage”.

The addition of additives can be easily carried out during handling using a powder spreader. The additives can be added as a separate powder. Preferably, additives, in particular the curing agent, are added in such a way that they are distributed substantially homogeneously throughout the resin powder. In contrast to the use of individual thermosetting composition and curing agent powders, segregation of the powders due to differences in density during the manufacturing process can be avoided and a homogeneous distribution of the curing agent throughout the fiber-matrix semi-finished product can be ensured. The system therefore preferably also comprises a curing agent which is dissolved and/or dispersed in the powder thermosetting resin composition. In another embodiment, the system comprises the curing agent as a separate powder. Preferably, however, the additives, in particular the curing agent, are dissolved and/or dispersed in the resin composition.

The invention also relates to the use of the protective device according to the invention in a battery structure. The invention also relates to the use of the protective device according to the invention for protecting a battery and/or a battery housing and/or for protecting against a battery, more precisely for protecting against dangers caused by a battery. The invention also relates to the use of an unsaturated compound, in particular of a thermosetting polymer material with at least one constitutional repeating unit that has an unsaturated carbon-carbon bond and/or an unsaturated carbon-nitrogen bond, in a protective device for a battery housing and/or a battery and/or a battery module, in particular in a protective device for a battery housing and/or a battery and/or a battery module of an electric vehicle. Particularly preferred is the use of a thermosetting polymer material obtained from a phenolic resin, in particular a novolak, by curing as a matrix material for a protective device for a battery housing, in particular in a protective device for a battery housing of an electric vehicle. The invention also relates to the use of a thermosetting polymer material obtained from a phenolic resin, in particular a novolak, by crosslinking as a matrix material in a battery structure comprising a protective device for a battery housing, and a battery housing and/or a battery and/or a battery module, wherein the protective device and/or the battery and/or the protective device and the battery housing and/or the protective device and the battery module are preferably connected to one another. Particularly preferably, the protective device is arranged on, in particular fastened to, one of the inner or outer sides of the battery housing and/or the battery.

The invention also relates to the production of a fiber-matrix semi-finished product and to a protective device made from this fiber-matrix semi-finished product. A method for producing the protective device comprises a first step for producing the fiber-matrix semi-finished product and a subsequent step for thermal finalization and is shown by way of an example below.

### Step 1: Production of the Fiber-Matrix Semi-Finished Product Via Powder Lamination

In the first step of manufacturing the protective device, novolak with a weight average molecular weight of ˜500 g/mol is applied to a textile, melted at a temperature of 120-130° C. and then pressed into the fiber material in the textile structure using a force (>5 N/cm²) using a double belt press. After cooling, a fiber-matrix semi-finished product is obtained. The degree of conversion, i.e., the extent of partial curing, of the thermosetting matrix material can be regulated via the pressing time and/or pressing temperature and/or the pressing pressure. This allows the brittleness of the material to be controlled. After cooling, the novolak is at the “B-stage”.

### Step 2: Thermal Finalization to Produce the Protective Device

In the subsequent second process step, the fiber-matrix semi-finished product obtained in step 1 is shaped into the desired net shape (e.g. L-profile, etc.) at an elevated temperature using shaping tools at approx. 140-170° C. Preferably, a plurality of fiber-matrix semi-finished products can be stacked on top of one another, i.e., a so-called stack can be formed, in order to obtain a uniform end product after final curing.

Steps 1 and 2 can be carried out continuously, i.e., directly following one another in time, or discontinuously, i.e., separated in time. By means of the method according to the invention, significantly thicker-walled components, such as laminates, can be produced than those known from the prior art. Conventional casting resin systems are generally difficult to work due to the amount of resin, the impregnation distance and the exothermic nature, so that component thickness is limited in this case. This is especially true for the conventional wet spraying process, where above a certain thickness the resin system can no longer completely infiltrate the fiber layers.

When using an RTM process, however, one or more sprue points are used, which then usually cannot be perfectly concealed optically. In addition, the sprue always leads to an uneven distribution of the matrix material, since the fiber material is very difficult to completely infiltrate due to the problems described above, especially in large structures.

Since, in the method according to the invention, the final component is obtained by joining thin layers that are almost completely impregnated with resin, these problems are not present in this case.

In one preferred embodiment of the invention, the protective device according to the invention is therefore a protective plate which has a thickness of ≥1 mm, preferably ≥1.5 mm, even more preferably ≥2.5 mm, even more preferably ≥3.5 mm and most preferably ≥5 mm. The fiber material is preferably substantially completely embedded (i.e., more than 95 vol. %) in such a protective plate. Preferably, this protective device is obtained by a method comprising the following steps:
I) manufacturing the fiber-matrix semi-finished product by
a) applying a dry powdered thermosetting resin composition, in particular a novolak, to produce a phenoplast, to a textile,
b) melting the resin composition at 100-150° C. and
c) applying a force to infiltrate the resin into the textile,
II) producing the protective device from one or more of the fiber-matrix semi-finished products produced under step I) by
a) optionally: stacking a plurality of fiber-matrix semi-finished products in a press
b) pressing the fiber-matrix semi-finished product or the stack of fiber-matrix semi-finished products at a temperature of 150° C. to 250° C., in particular 160° C. to 180° C.

The method according to the invention also allows the use of fine-mesh fabrics with a low basis weight (≤200 g/m²), which cannot be processed in conventional manufacturing processes such as wet pressing due to the difficulty of infiltration. The invention therefore preferably relates to a fiber-matrix semi-finished product and to a protective device comprising fine-mesh fabric with a basis weight ≤200 g/m², preferably ≤150 g/m², even more preferably ≤120 g/m², and most preferably ≤90 g/m². Preferably, the protective device with a corresponding trade is obtained by means of a method comprising the steps defined above.

### BRIEF DESCRIPTION OF THE FIGURES

The present invention is explained in more detail below with reference to the exemplary embodiments indicated in the figures.

FIG. 1 schematically shows step 1 of a method for producing a protective device according to the invention.

FIG. 2 schematically shows step 2 of a method for producing a protective device according to the invention.

FIG. 3 schematically shows a multi-matrix protective device with locally different matrix systems.

FIG. 4 schematically shows step 1 of a method for producing a protective device according to the invention.

### DETAILED DESCRIPTION

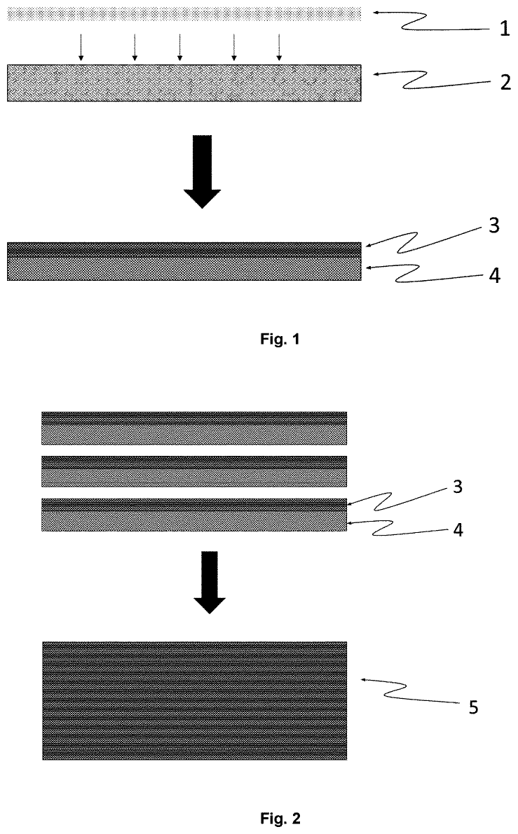

FIG. 1 and FIG. 4 schematically show, by way of example, a method for producing the protective device according to the invention, i.e., the composite component, as can be used, for example, for a cover or base of a battery housing for an electric vehicle.

To produce such a composite component, an unwinder is fitted with a glass cloth. The total grammage of the glass cloth as well as the distribution of the proportions of different fiber directions (e.g., below 0°, + and −45° and 90° in relation to the longitudinal axis of the vehicle) are determined during the design process according to the mechanical and other loads on the cover/base. In a simple basic structure, the proportions of the direction of travel in 0°, −45°, 45° and 90°are equal, so that a so-called quasi-isotropic laminate is used.

Using the unwinder, the glass fabric is fed into a powder laminating system with a powder spreader. With the help of the powder spreader, a resin-curing agent mixture in the form of a powder is spread over the surface of the fabric and then fed into a double belt press (press temperature ˜120° C.). The resin material is a novolak resin with a weight average molecular weight of ˜500 g/mol, with the curing agent being hexamine. The resin material is thereby pressed into the fabric and the reinforcing fibers are embedded in the resin. This process step is shown schematically in FIGS. 1 and 4. After cooling to room temperature, the resulting prepreg material is cut and/or rolled up or stacked. The resulting fiber-matrix semi-finished product, in this case the prepreg material, is at room temperature (˜23° C.) (i.e., there is no conversion to the “C-stage”over a period of at least two days) and it exhibits essentially no tackiness.

To produce the protective device, the semi-finished product is cut to shape in step 2 of the method and stacked to a desired thickness. The stack is then placed in an open press with a crimping edge, the press is closed and the component is pressed in a path-controlled manner at a temperature of 160-170° C., thereby completely curing the matrix material. The curing time is a plurality of minutes. This process step is shown schematically in FIG. 2.

The component is then removed from the mold and fed to the final processing steps.

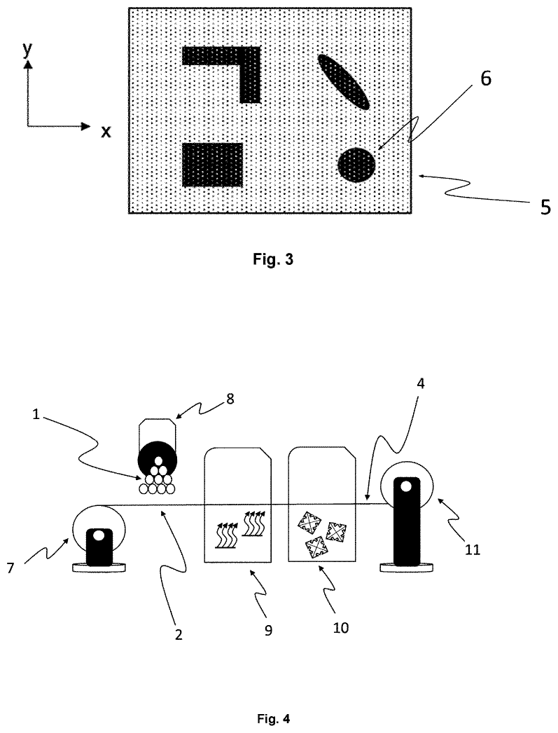

Depending on the arrangement of the battery cells in the housing, certain regions of the cover are exposed to particularly high temperatures in the event of a battery fire. In one embodiment of the invention, the matrix material of the protective device therefore only comprises an unsaturated matrix material, e.g. a novolak, at the locations exposed to particularly high loads. Such locations are highlighted in black in the schematic depiction of FIG. 3.

### REFERENCE SIGNS

1 Curable resin composition in powder form
2 Textile fiber material layer
3 Fully resin-coated surface-side fiber-matrix semi-finished product
4 Fiber-matrix semi-finished product
5 Protective device
6 Novolak-enriched matrix zone of the protective device
7 Unwinder with glass fiber fabric
8 Powder spreader
9 Heating zone of the double belt press
10 Cooling zone of the double belt press
11 Winding device with semi-finished product

1-15. (canceled)

16. A battery structure comprising a battery housing and/or a battery, and a protective device, wherein the protective device has a
a) fiber material comprising long and/or continuous fibers, and
b) a matrix material,
wherein the fiber material is at least partially, preferably completely, embedded in the matrix material,
wherein the matrix material comprises or consists of an unsaturated compound, preferably an unsaturated polymer.

17. The battery structure according to claim 16, wherein the protective device comprises the fiber material at least in portions, preferably completely, in the form of a preferably textile surface structure.

18. The battery structure according to claim 17, wherein the textile surface structure is selected from the group consisting of laid scrim, woven fabric, non-woven fabric or combinations of the aforementioned.

19. The battery structure according to claim 16, wherein the fibers of the fiber material are selected from the group consisting of glass fibers, carbon fibers, basalt fibers, ceramic fibers, steel fibers, polymer fibers such as synthetic fibers, in particular aramid and nylon fibers, or natural polymer fibers such as flax, hemp or protein fibers.

20. The battery structure according to claim 16, wherein the unsaturated compound is a thermosetting polymer material with at least one constitutional repeating unit having at least one functional group that has an unsaturated carbon-carbon bond and/or an unsaturated carbon-nitrogen bond.

21. The battery structure according to claim 20, wherein the functional group comprises an unsaturated carbon-carbon double bond.

22. The battery structure according to claim 20, wherein the functional group has two or more bonds selected from the group consisting of unsaturated carbon-carbon bonds and unsaturated carbon-nitrogen bonds and wherein at least two of these bonds are conjugated.

23. The battery structure according to claim 20, wherein the at least one functional group is selected from the group consisting of carbon-carbon double bonds, carbon-carbon triple bonds, imino groups, aromatics and nitrile groups and/or the at least one functional group is part of one of the following substituents: alkenyl, alkynyl, nitrile, furanyl, thiophenyl, pyrolyl, imidazolyl, pyrazolyl, oxazolyl, thiazolyl, phenyl, benzoyl, hydroxyphenyl or pyiridinyl.

24. The battery structure according to claim 16, wherein the protective device is designed in one piece or has a sandwich construction.

25. The battery structure according to claim 16, wherein the unsaturated compound is a thermosetting polymer produced by curing a curable resin composition, wherein the resin of the resin composition is preferably selected from the group consisting of phenolic resins, in particular novolaks, melamine resins, polyurethane resins and mixtures of the aforementioned.

26. The battery structure according to claim 16, wherein the battery structure has a battery housing and the protective device is the battery housing or a part of the battery housing, preferably a bottom plate or cover plate.

27. A protective device for a battery housing and/or battery and/or a battery module as defined in claim 16.

28. The protective device according to claim 27, wherein the protective device is a component of a means of transport, preferably a motor vehicle component or a part thereof, preferably a component of a battery housing, particularly preferably the bottom plate or cover plate.

29. A fiber-matrix semi-finished product for producing a protective device according to claim 27, comprising
a) a fiber material comprising long and/or continuous fibers,
b) a curable resin composition comprising an unsaturated compound,
wherein the fiber material is at least partially, preferably completely, embedded in the curable resin composition.
